(19) United States
(12) Patent Application Publication
(10) Pub. No.: US 2021/0297735 A1
(43) Pub. Date: Sep. 23, 2021

(54) VIDEO PLAYBACK METHOD AND APPARATUS AND COMPUTER STORAGE MEDIUM

(71) Applicant: MediaTek Singapore Pte. Ltd., Singapore (SG)

(72) Inventor: Xiaoming DING, Wuhan (CN)

(21) Appl. No.: 17/159,440

(22) Filed: Jan. 27, 2021

(30) Foreign Application Priority Data
Mar. 22, 2020 (CN) 202010204786.4

(51) Int. Cl. H04N 21/44; H04N 21/81; H04N 21/8358; H04N 21/61; H04N 21/458

(52) U.S. Cl. CPC H04N 21/44016; H04N 21/812; H04N 21/458; H04N 21/6175; H04N 21/8358

(57) ABSTRACT

A video playback method and apparatus are provided. The video playback method includes receiving a first video stream, playing the first video stream on a first playing path, and outputting content of the first playing path; acquiring tag information of the first video stream and, based on the tag information, playing a second video stream on a second playing path; and stopping output of the content of the first playing path and outputting content of the second playing path based on the tag information. Through the video playback method of the present application, advertisements can be dynamically switched effectively, thereby improving the viewing experience of the user.

### CROSS REFERENCE TO RELATED APPLICATIONS

This Application claims priority of China Patent Application No. 202010204786.4, filed on Mar. 22, 2020, the entirety of which is incorporated by reference herein.

### BACKGROUND OF THE INVENTION

### Field of the Invention

This invention is related to the field of computer processing technology and, in particular to, a video playback method and apparatus and a computer storage medium.

### Description of the Related Art

Media consumption apparatuses, such as smart TVs, can receive various streaming media data from the Internet, which allows the user to access a variety of content, such as movies, video lectures, etc., while being at home. At present, the resources of free video programs on the Internet are becoming more and more abundant. If only the fees of the video programs are used to support provision of services to users, there will be great limitations and market risk. Therefore, providing users with free program content based on profit models of TV programs and charging advertisers advertising fees by broadcasting a certain amount of advertisements to viewers has become a mature profit model.

On the current market, insertion of advertisements in videos programs basically uses a fixed advertising model: that is, advertisements are inserted in video streams. If it is desired that customized advertisements be provided to users, different video streams need to be sent to different customers, which is expensive. Thus, the market urgently needs a method and device for implementing the dynamic insertion of advertisements.

### BRIEF SUMMARY OF THE INVENTION

This application provides a video playback method, a video playback apparatus, and a computer storage medium, and the main technical problem to be solved is how to implement dynamic insertion of advertisements.

In order to solve the technical problems described above, a video playback method applied on a user terminal is provided. The video playback method comprises the following steps: receiving a first video stream, playing the first video stream on a first playing path, and outputting content of the first playing path; acquiring tag information of the first video stream and, playing a second video stream on a second playing path based on the tag information; and stopping output of the content of the first playing path and outputting content of the second playing path based on the tag information.

In order to solve these problems listed above, a video playback apparatus is also provided. The video playback apparatus comprises a memory and a processor coupled to the memory. The processor is configured to: receive a first video stream, play a first video stream on a first playing path, and output content of the first playing path; acquire tag information of the first video stream and, play a second video stream on a second playing path based on the tag information; and stop output of the content of the first playing path while output content of the second playing path based on the tag information.

The present application also provides a computer storage medium. The computer storage medium is used to store a program instruction, and the program instruction causes a processor to execute the video playback method.

A detailed description is given in the following embodiments with reference to the accompanying drawings.

### BRIEF DESCRIPTION OF THE DRAWINGS

The following description is of the best-contemplated mode of carrying out the invention. This description is made for the purpose of illustrating the general principles of the invention and should not be taken in a limiting sense. The scope of the invention is best determined by reference to the appended claims:

FIG. 1 is a schematic flow chart of a first embodiment of a video playback method provided by the present application;

FIG. 2 is a schematic flow chart of a second embodiment of a video playback method provided by the present application;

FIG. 3 is a timing diagram of playing videos in the embodiment shown in FIG. 2;

FIG. 4 is a schematic flow chart of a third embodiment of a video playback method provided by the present application;

FIG. 5 is a block diagram of an embodiment of a video playback apparatus provided by the present application;

FIG. 6 is a block diagram of another embodiment of a video playback apparatus provided by the present application; and

FIG. 7 is a block diagram of an embodiment of a computer storage medium provided by the present application.

### DETAILED DESCRIPTION OF THE INVENTION

The following will clearly and completely describe the solutions in the embodiments of the present application in conjunction with the drawings in the embodiments of the present application. Obviously, the described embodiments are only a part of the embodiments of the present application, not all of them. Based on the embodiments in the present application, all other embodiments obtained by those skilled in the art, without creative work, are within the protection scope of the present application.

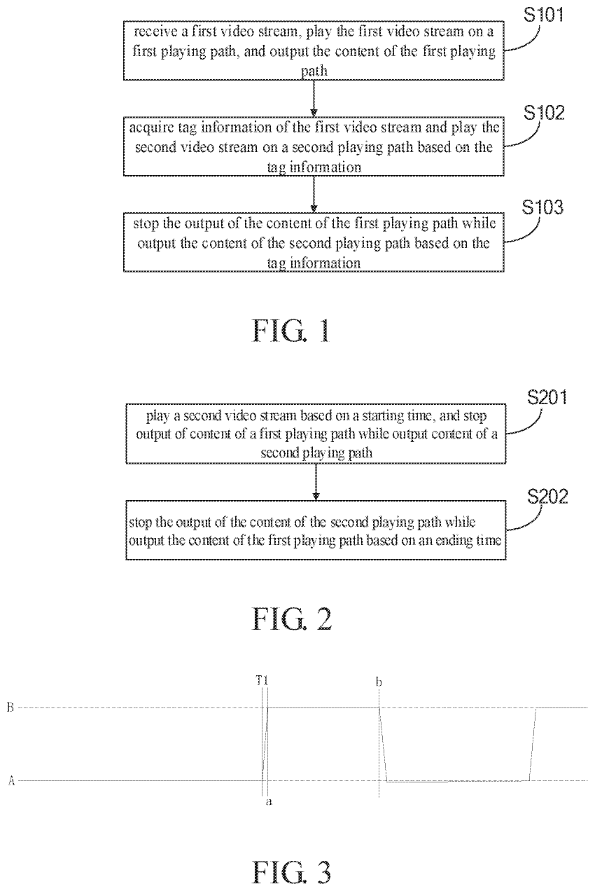

In order to solve the technical problem that the dynamic insertion of advertisements cannot be effectively implemented in the prior art, the present application provides a video playback method. Please refer to FIG. 1 for details. FIG. 1 is a schematic flow chart of a first embodiment of a video playback method provided by the present application. The video playback method provided in this application is applied to a video playback apparatus. The video playback apparatus may be a terminal apparatus, such as a smart TV, a smart phone, a tablet computer, a notebook computer, a computer, or a wearable device. In the following embodiments, a video playback method and related apparatus are described.

As shown in FIG. 1, the video playback method of the embodiment specifically comprises the following steps:

S101: receiving a first video stream, playing the first video stream on a first playing path, and outputting the content of the first playing path.

In an embodiment, the video playback apparatus receives the first video stream from a server. The server can be a service provider of network videos or TV videos.

The video playback apparatus comprises the first playing path and sets the first playing path as the primary output path. The video playback apparatus inputs the first video stream to the first playing path, so that the first playing path plays the first video stream. When the video playback apparatus plays videos, the first video stream of the first playing path is output by default. At this time, what the user watches through the video playback apparatus is the content of the first video stream.

In an embodiment, the first video stream of the present application may be a program video stream.

S102: acquiring a tag information of the first video stream and playing the second video stream on the second playing path based on the tag information.

In an embodiment, the video playback apparatus further comprises the second playing path and sets the second playing path as an auxiliary output path. The video playback apparatus inputs the second video stream to the second playing path, and the second playing path plays the second video stream. When playing the second video stream, the video playback apparatus outputs the second video stream of the second playing path based on the tag information.

In an embodiment, the second video stream of the present application may be an advertisement video stream.

S103: stopping the output of the content of the first playing path while outputting the content of the second playing path based on the tag information.

In an embodiment, the video playback apparatus stops outputting the content of the first playing path according to the advertising time that is defined by the tag information and outputs the content of the second playing path simultaneously.

Specifically, during the advertising time as defined by the tag information, the video playback apparatus stops the output of the content of the first video stream on the first playing path while outputs the content of the second video stream on the second playing path. For example, the video playback apparatus mutes the output of the audio signal and video signal of the first playing path and outputs the audio signal and video signal of the second playing path instead.

Thus, in cases where the first video stream is a program video stream while the second video stream is an advertisement video stream, the video playback apparatus can play the content of the advertisement video stream during the advertising time on the program video stream, so that the user will see the inserted advertisement during the advertising time of the program video stream, thereby implementing the dynamic insertion of advertisements.

In the embodiment, the video playback apparatus receives the first video stream, plays the first video stream on the first playing path, and outputs the content of the first playing path. The video playback apparatus further acquires the tag information of the first video stream and plays the second video stream on the second playing path based on the tag information. The video playback apparatus stops the output of the content of the first playing path while outputs the content of the second playing path based on the tag information. Advertisements can be switched dynamically by using the video playback method disclosed herein, and the viewing experience of the users can be improved.

Based on Step 103 in the above embodiment, another video playback method is provided, which is illustrated in detail in FIG. 2. FIG. 2 is a schematic flow chart of a second embodiment of the video playback method provided by the present application.

As shown in FIG. 2, the video playback method of the embodiment comprises the following steps:

S201: playing the second video stream based on a starting time, and stopping the output of the content of the first playing path while outputting the content of the second playing path.

In an embodiment, Step S201 is illustrated in detail in FIG. 3. The tag information acquired by the video playback apparatus from the first video stream comprises at least a starting time and an ending time. The starting time is the time point when the advertisement starts to be played in the first video stream, and the ending time is the time point when the advertisement is stopped. The number of advertisement periods in the first video stream corresponds to the number of sets of starting time and ending time.

As shown in FIG. 3, the time point a is the starting time in the tag information, and the time point b is the ending time in the tag information. The solid line in FIG. 3 is the video stream output by the video playback apparatus. Before the time point a, the video playback apparatus uses the first video stream A as the output video stream. When the time reaches the time point a, the video playback apparatus switches the output path to the second playing path: that is, the video playback apparatus switches to output the second video stream B, so that the video playback apparatus changes from playing the first video stream A to playing the second video stream B.

Furthermore, in order to avoid screen jam or screen overlap during the switching between the playing paths, the video playback apparatus has a predetermined buffer time T1. Before the buffer time T1, which is earlier than time point a, the video playback apparatus starts to load the second video stream B into the second playing path.

S202: stopping the output of the content of the second playing path while outputting the content of the first playing path based on the ending time.

In an embodiment, during the period between the time point a and the time point b, the video playback apparatus uses the second video stream B as the output video stream. When the time reaches the time point b, the video playback apparatus switches the output path to the first playing path: that is, the video playback apparatus switches to output the first video stream A, so that the video playback apparatus switches to play the original program video again.

The tag information in the embodiment may be watermark information. The watermark information can be generated by the service provider that generates the first video stream according to the advertising time of the first video stream and inserted into the first video stream, so that the user terminal acquiring the first video stream can learn the advertising playing time in the first video stream by identifying the watermark information in the video stream. Accordingly, the user terminal can prepare customized advertisements in advance and replace the advertisements in the first video stream with customized advertisements.

In the embodiment, the video playback apparatus switches between the first playing path and the second playing path according to the starting time and ending time in the first video stream. Furthermore, the video playback apparatus predetermines the buffer time, which can effectively avoid screen jam or overlap during the switching between the playing paths, thereby improving the effect of the dynamic insertion of advertisements.

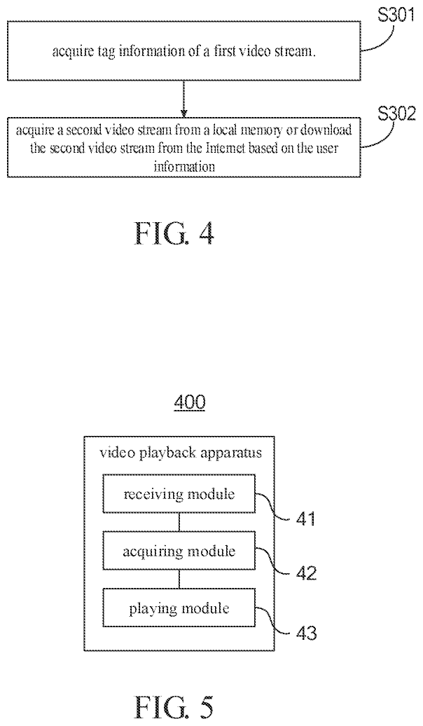

Based on Step 102 in the above embodiment, the present application provides another specific video playback method, which is illustrated in detail in FIG. 4. FIG. 4 is a schematic flow chart of a third embodiment of the video playback method provided by the present application.

As shown in FIG. 4, the video playback method of the embodiment comprises the following steps:

S301: acquiring tag information of the first video stream.

In an embodiment, when acquiring the first video stream, the video playback apparatus can traverse the first video stream to discover the location of the tag information or monitor the tag information in real time when the first video stream is played.

S302: acquiring the second video stream from the local memory or downloading the second video stream from the Internet based on the user information.

In an embodiment, after acquiring the tag information, the video playback apparatus customizes the second video stream based on the user information. In a case, based on the user information, the video playback apparatus may query the local memory for a video file with the same or similar tag as the user information as the second video stream. In another case, the video playback apparatus may download from the Internet based on the user information as the second video stream related to user information.

Specifically, the user information may comprise, but is not limited to, the following information: identity information, custom information, and preference information. For example, the identity information may comprise gender, age, account information, etc., the custom information may comprise user surfing history, usage time, etc., and the preference information can be the information that reflect user preferences, interests, and shopping intentions. For example, if the video playback apparatus detects that the user watched a movie recently, the video playback apparatus can acquire the related advertisements of the movie based on the movie information as the second video stream, thereby realizing the customization of the customized advertisements for the user.

In order to implement the video playback method of any one of the above embodiments, the present application provides a video playback apparatus, which is illustrated in detail in FIG. 5. FIG. 5 is a block diagram of an embodiment of the video playback apparatus provided by the application.

As shown in FIG. 5, the video playback apparatus 400 of the embodiment comprises a receiving module 41, an acquiring module 42 and a playing module 43.

In an embodiment, the receiving module 41 is configured to receive the first video stream.

The playing module 43 is configured to play the first video stream on the first playing path and output the content of the first playing path.

The acquiring module 42 is configured to acquire the tag information of the first video stream.

The playing module 43 is also configured to play the second video stream on the second playing path based on the tag information and, based on the tag information, stop the output of the content of the first playing path while output the content of the second playing path.

Although the embodiment of FIG. 5 provided by the present application shows separate modules, those skilled in the art can understand that the modules shown in the above embodiment may be combined into a single module or split into multiple modules for performing the functions presented by the embodiments of the present application. For example, the modules 41˜43 may be one or more circuits configured to perform specific tasks.

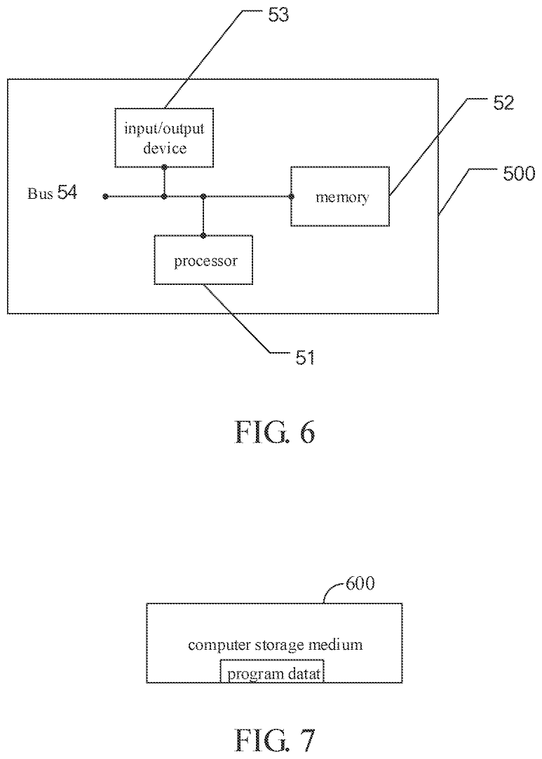

In order to implement the video playback method of the above embodiments, the present application also provides another video playback apparatus, which is illustrated in detail in FIG. 5. For more details, please refer to FIG. 6, which is a block diagram of another embodiment of the video playback apparatus provided by the present application.

As shown in FIG. 6, the video playback apparatus 500 of the embodiment comprises a processor 51, a memory 52, an input/output device 53, and a bus 54.

The processor 51, the memory 52, and the input/output device 53 are respectively connected to the bus 54. A computer program is stored in the memory 52, and the processor 51 is configured to execute the computer program to realize the video playback method described in any one of the above embodiments.

In the embodiment, the processor 51 may also be referred to as a central processing unit (CPU). The processor 51 may be an integrated circuit chip with signal processing capability. The processor 51 may also be a general-purpose processor, a digital signal processor (DSP), an application specific integrated circuit (ASIC), a field programmable gate array (FPGA) or another programmable logic device, a discrete gate or transistor logic device, a discrete hardware device. The general-purpose processor may be a microprocessor, or the processor 51 may also be any conventional processor.

The present application also provides a computer storage medium. As shown in FIG. 7, the computer storage medium 600 is used to store program data. When the program data is executed by a processor, the video playback method in any of the embodiments provided by the present application can be implemented.

The methods involved in the embodiments of the video playback method of the present application, when implemented in the form of software functional units and sold or used as independent products, can be stored in a device, such as a computer readable storage medium. Based on this understanding, the essential solution of the present application, the part of the solution that contributes to the existing technology, or all or part of the solution can be embodied in the form of a software product. The computer software product is stored in a storage medium and comprises several instructions to cause a computer device (which may be a personal computer, a server, or a network device, etc.) or a processor to execute all or part of the steps of the method described in each of the various embodiments of the present application. The aforementioned storage media may comprises a semiconductor or solid-state memory, an USB memory, a removable hard disk, a read-only memory (ROM), a random access memory (RAM), a magnetic disk, an optical disk, or a suitable storage media that can store program codes.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

What is claimed is:

1. A video playback method, applied on a user terminal, the video playback method comprising:
receiving a first video stream, playing the first video stream on a first playing path, and outputting content of the first playing path;
acquiring tag information of the first video stream and, based on the tag information, playing a second video stream on a second playing path; and
stopping output of the content of the first playing path while outputting content of the second playing path based on the tag information.

2. The video playback method as claimed in claim 1, wherein:
the tag information comprises a starting time, and
based on the starting time, the second video stream is played, and the content of the first playing path stops being output while the content of the second playing path is output.

3. The video playback method as claimed in claim 2, wherein:
the tag information further comprises an ending time, and
based on the ending time, the content of the second playing path stops being output while the content of the first playing path is output.

4. The video playback method as claimed in claim 3, wherein the tag information is watermark information, and the starting time and the ending time indicate an advertising time in the first program video stream.

5. The video playback method as claimed in claim 3, wherein the second video

6. The video playback method as claimed in claim 1, wherein the second video stream is acquired from a local memory based on user information, or the second video stream is downloaded from the Internet based on the user information.

7. The video playback method as claimed in claim 6, wherein the user information comprises identity information, custom information, and preference information.

8. The video playback method as claimed in claim 1, wherein the first video stream is a program video stream, and the second video stream is an advertisement video stream.

9. A video playback apparatus, comprising a memory and a processor coupled to the memory, wherein the processor is configured to:
receive a first video stream, play a first video stream on a first playing path, and output content of the first playing path;
acquire tag information of the first video stream and, based on the tag information, play a second video stream on a second playing path; and
stop output of the content of the first playing path while output content of the second playing path based on the tag information.

10. A computer storage medium for storing a program instruction that causes a processor to execute a video playback method, the video playback method comprising:
receiving a first video stream, playing the first video stream on a first playing path, and outputting content of the first playing path;
acquiring tag information of the first video stream and, based on the tag information, playing a second video stream on a second playing path; and
stopping output of the content of the first playing path while outputting content of the second playing path based on the tag information.
